(19) United States
(12) Patent Application Publication
(10) Pub. No.: US 2026/0278583 A1
(43) Pub. Date: Sep. 17, 2026

(54) SMARTPHONE-COMPATIBLE CONTACTLESS IC CARD WITH FINGERPRINT AUTHENTICATION FUNCTION

(71) Applicant: MUTER CO., LTD., Nara (JP)

(72) Inventor: Masaya OKITA, Saitama (JP)

(73) Assignee: MUTER CO., LTD., Nara (JP)

(21) Appl. No.: 18/875,701

(22) PCT Filed: Jun. 5, 2023
(86) PCT No.: PCT/JP2023/020841

§ 371 Date: Dec. 16, 2024

(30) Foreign Application Priority Data
Jun. 17, 2022 (JP) 2022-098398

(51) Int. Cl. G06Q 20/34; G06Q 20/32; G06Q 20/40

(52) U.S. Cl. CPC G06Q 20/352; G06Q 20/3278; G06Q 20/40145

(57) ABSTRACT

A contactless IC card with a smartphone-compatible fingerprint authentication function which can recognize successful fingerprint authentication by a smartphone incorporating a contactless IC card reader is provided. A fingerprint sensor, a fingerprint authentication portion, a memory for storing verification fingerprint data, a coil for receiving power from the contactless IC card reader, and a first NFC chip having a function of performing NFC communication with the contactless IC card reader are provided. The fingerprint data read by the fingerprint sensor is verified against the verification fingerprint data stored in the memory by the fingerprint authentication portion. When it is authenticated that the fingerprints match each other, the matching is notified from the IC chip to the contactless IC card reader by the NFC communication. By causing a second NFC chip in an initial response of the NFC communication to be recognized, continuous power-supply is performed from the contactless IC card reader to the coil.

### TECHNICAL FIELD

The present invention relates to a smartphone-compatible contactless IC card with a fingerprint authentication function incorporating a contactless IC card reader.

### BACKGROUND ART

The contactless IC card has been used in various fields in recent years. In Japan in particular, a contactless IC card based on a FeliCa (Registered Trademark) card is widely used as a season ticket for public transportation facilities and electronic money.

In the FeliCa card, one FeliCa chip having functions for storing data for the NFC (Near Field Communication), the electronic money and the like is mounted on each card. In addition, the FeliCa card has a specific ID number also called an “IDm” and recorded at the manufacture of the FeliCa chip. The IDm data cannot be rewritten.

This IDm is strictly managed by manufacturers. That is, the IDm is strictly managed such that the FeliCa chip with the same IDm data is only one in the world and does not exist at any other places. Furthermore, since counterfeiting is technically difficult, the FeliCa card using the IDm data is widespread as a key to be interlocked with security-related devices such as an electric lock, an entrance/exit management system, an attendance management system, printing management of a printer and the like.

However, a usual FeliCa card does not have a function for identification by biometric authentication. As a result, it is difficult to prevent impersonation and use by the others. Therefore, a security system with two-factor authentication combining biometric authentication functions such as face authentication, fingerprint authentication and the like is increasingly in demand.

Recently, a contactless IC card with a fingerprint authentication function incorporating a fingerprint authentication function in a card has been developed/sold as a contactless IC card which can prevent impersonation. With the contactless IC card with a fingerprint authentication function which has been developed particularly for security, such a card that the fingerprint authentication function is incorporated in the card, the fingerprint authentication is performed by wireless power-supply from a contactless IC card reader, and when the fingerprint authentication succeeds, the card is operated as a FeliCa card is sold in the market. This is a result of consideration on points of its ease in introduction such as availability without changing the devices/systems related to the security using the existing FeliCa card and mixed usability with a usual FeliCa card.

In addition, a card which adopted such a method that all the circuits in the card are operated only by electric power supplied wirelessly from a contactless IC card reader is sold. By realizing a card without a battery mounted, there is no problem including maintenance such as charging, deterioration of the battery or the like. It is even advantageous in cost since it has no battery.

With the contactless IC card with a fingerprint authentication function without incorporating a battery, the fingerprint authentication portion inside the card needs calculation time for 1 to 2 seconds for authentication of the fingerprint. During a period until the fingerprint authentication including this calculation time is finished, the finger authentication succeeds, and the operation as a FeliCa card starts, such a state needs to be kept that a coil in the card can continuously receive required power.

Most of the contactless IC card readers currently in the market have such a capability that continuously supplies power for completing the finger authentication to the contactless IC card with a fingerprint authentication function not incorporating a battery as hardware. However, in a usual FeliCa card, the NFC communication with the contactless IC card reader ends in a short time and thus, there are extremely many systems that do not support continuous power-supply on the card-reading software side.

In a system such as an electric lock, the aforementioned request for continuous power-supply can be easily responded by replacing to a contactless IC card reader that supports continuous power-supply with firmware in the contactless IC card reader. In a system that connects the contactless IC card reader to a personal computer, response can be made by changing software for controlling the contactless IC card reader installed in the personal computer.

On the other hand, in the security system using the FeliCa card, such a system that reads out specific data such as the IDm or the like of the card via the Internet and responds to remote control or the like will be a mainstream from now. In this case, to use the personal computer only for sending the information read by the contactless IC card reader to the network is not convenient in terms of costs, power consumption, place for installation and the like. The contactless IC card reader specialized for network connection is sold in the market, but the price is high.

As hardware for reading the specific data such as IDm of the FeliCa card and sending it to the security system via the network, the inventor of the present application considered use of a smartphone incorporating the contactless IC card reader. In the smartphone, there is no need to add hardware in order to read the specific data such as IDm or the like of the contactless IC card with a fingerprint authentication function by the incorporated contactless IC card reader and to send the specific data such as IDm or the like or an authentication result to the security system by a telephone line or WiFi connection via the network, but they can be responded only by installing application software.

Moreover, even a smartphone which is old and has not been used or a used smartphone has sufficient capabilities to send the specific data such as IDm or the like of the contactless IC card with a fingerprint authentication function or the authentication result to the system via the network. Furthermore, the inventor thought that, only by installing the application software also in the smartphone carried by a user, it can handle the contactless IC card with a fingerprint authentication function.

Also, as known, in recent years, from the viewpoint of further reinforcement of security, authentication by multi-factor authentication combining a plurality of authentication functions is in demand. Moreover, high-amount damages caused by a new method that disables face authentication or fingerprint authentication incorporated in the smartphone, called a SIM swap attack occur overseas, and the damage is expected to rapidly rise in the future in Japan, too. As an imminent problem, a biometric-authentication device that can be used in a smartphone, which is effective also against the SIM swap attack, is in demand.

### SUMMARY OF INVENTION

### Technical Problem

The inventor of this application created application software to be applied to iPhone (Registered Trademark) by Apple, Inc in the States and verified an actual operation. As the result of this verification, such problems were found that continuous power-supply cannot be performed in order to complete the fingerprint authentication by the contactless IC card with a fingerprint authentication function not incorporating a battery and that the IDm cannot be read, either, only with the application software due to limitation of the OS. Therefore, such hardware could not be realized that performs the fingerprint authentication by the contactless IC card with a fingerprint authentication function by using the iPhone and sends the specific data such as the IDm or the like or the authentication result to the system via the network.

An object of the present invention is, in a smartphone incorporating a contactless IC card reader, for a model in which continuous power-supply cannot be performed from the contactless IC card reader only by the installed application software, by enabling continuous power-supply from the contactless IC card reader by the contactless IC card reader through recognition of an NFC chip added into the contactless IC card with a fingerprint authentication function and by performing the fingerprint authentication by the contactless IC card with a fingerprint authentication function, to provide such a contactless IC card with a smartphone-compatible fingerprint authentication function that can send the specific data such as IDm and the like or the authentication result to the system via the network.

### Solution to Problem

According to one viewpoint of the present invention,
the aforementioned object is achieved by providing a contactless IC card with a smartphone-compatible fingerprint authentication function, which is a contactless IC card with a smartphone-compatible fingerprint authentication function which can recognize successful fingerprint authentication by a smartphone incorporating a contactless IC card reader, including:
a fingerprint sensor;
a fingerprint authentication portion;
a memory for storing verification fingerprint data;
a first coil for receiving power from the contactless IC card reader; and
fingerprint authentication means including a first NFC chip having a function of performing NFC communication with the contactless IC card reader, characterized in that the fingerprint authentication means has:
a fingerprint-data reading function which starts reading of fingerprint data by using the fingerprint sensor, when the first coil receives power from the contactless IC card reader;
a fingerprint-data verification function which matches the read fingerprint data against the verification fingerprint data stored in the memory by the fingerprint authentication portion; and
a fingerprint-authentication notification function of notifying to the contactless IC card reader that the fingerprints are authenticated to match each other, since the first NFC chip can perform the NFC communication only when the fingerprints are authenticated to match each other by the fingerprint authentication portion;
the fingerprint sensor, the fingerprint authentication portion, the memory, the first NFC chip operate only by the power received by the first coil; the smartphone is a model in which continuous power-supply cannot be performed from the contactless IC card reader to the first coil only by the application software installed therein, including:
a second NFC chip, which is different from the first NFC chip; and
when the power is received by the first coil from the contactless IC card reader, in an initial response of the NFC communication, by causing the second NFC chip to be recognized, the continuous power-supply is performed from the contactless IC card reader to the first coil.

According to another viewpoint of the present invention,
the aforementioned object is achieved by providing a contactless IC card with a smartphone-compatible fingerprint authentication function, which is a contactless IC card with a smartphone-compatible fingerprint authentication function which can recognize successful fingerprint authentication by a smartphone incorporating a contactless IC card reader, including:
a fingerprint sensor;
a fingerprint authentication portion;
a memory for storing verification fingerprint data;
a first coil for receiving power from the contactless IC card reader; and
fingerprint authentication means including a first NFC chip having a function of performing NFC communication with the contactless IC card reader, characterized in that the fingerprint authentication means has:
a fingerprint-data reading function which starts reading of fingerprint data by using the fingerprint sensor, when the first coil receives power from the contactless IC card reader;
a fingerprint-data verification function which matches the read fingerprint data against the verification fingerprint data stored in the memory by the fingerprint authentication portion; and
a fingerprint-authentication notification function of notifying to the contactless IC card reader that the fingerprints are authenticated to match each other, since the first NFC chip can perform the NFC communication only when the fingerprints were authenticated to match each other by the fingerprint authentication portion;
the fingerprint sensor, the fingerprint authentication portion, the memory, the first NFC chip operate only by the power received by the first coil;
the smartphone is a model in which continuous power-supply cannot be performed from the contactless IC card reader to the first coil only by the application software installed therein, including:
a second NFC chip, which is different from the first NFC chip;
a second coil, which is different form the first coil; and
when the power is received by the second coil from the contactless IC card reader, in an initial response of the NFC communication, by causing the second NFC chip to be recognized, the continuous power-supply is performed from the contactless IC card reader to the first coil.

That is, in the present invention, the fingerprint authentication means mounted on the contactless IC card with a smartphone-compatible fingerprint authentication function starts fingerprint authentication by wireless power-supply from the contactless IC card reader incorporated in the smartphone, and the smartphone recognizes that the fingerprints match each other by the contactless IC card reader performing the NFC communication with the first NFC chip incorporated in the contactless IC card with a smartphone-compatible fingerprint authentication function. Even in a model in which the continuous power-supply required for this fingerprint authentication means cannot be performed only by application software installed in the smartphone, the continuous power-supply is made possible by causing the second NFC chip to be recognized in the initial response in the NFC communication at the start of the power-supply.

According to a preferred embodiment of the present invention, matching of the data using the specific data on the side of the contactless IC card with a smartphone-compatible fingerprint authentication function with the registered data on the smartphone side is confirmed on the smartphone side. As a result, high security can be provided on the basis of the two-factor authentication. The electronic circuit on the side of the contactless IC card with a smartphone-compatible fingerprint authentication function is operated only by power supplied by the wireless power-supply from the contactless IC card reader. Therefore, there is no need to mount a battery on the side of the contactless IC card with a smartphone-compatible fingerprint authentication function, and there is no problem, either, such as maintenance including charging, deterioration of the battery and the like.

According to another preferred embodiment of the present invention, by enabling use of the contactless IC card with a smartphone-compatible fingerprint authentication function in a state stored in a smartphone case or use in a state bonded to the smartphone while avoiding projections such as a camera of the smartphone by reducing the size of the card smaller than a credit card size, use in an integrated state is enabled almost without increasing a thickness of the smartphone. And the function and convenience to use equal to those of the fingerprint authentication device incorporated in the smartphone can be provided.

In recent years, it is required for the contactless IC card reader of a smartphone not only to read a card but also to perform the NFC communication with various external devices of payment of electronic money and the like. Even in a state where the contactless IC card with a smartphone-compatible fingerprint authentication function is integrated with the smartphone, the example of the present invention can use the smartphone without interfering with the NFC communication, when the contactless IC card reader performs the NFC communication with another IC card or in the case of the NFC communication with various external devices including the external contactless IC card reader.

### BRIEF DESCRIPTION OF DRAWINGS

FIG. 1 is a block diagram of a fingerprint authentication system related to the present invention.

FIG. 2 is a flowchart for explaining an example of an operation of application software installed in a smartphone for controlling the fingerprint authentication system related to the present invention on the smartphone side.

FIG. 3 is a timing chart of a first example for explaining a power-supply state to a coil.

FIG. 4 is a timing chart of a second example for explaining a power-supply state to a coil.

FIG. 5 is a timing chart of a third example for explaining a power-supply state to a coil.

FIG. 6 is a timing chart of a fourth example for explaining a power-supply state to a coil.

FIG. 7 is a timing chart of a fifth example for explaining a power-supply state to a coil.

FIG. 8 is an explanatory diagram of an example of bonding the contactless IC card with a fingerprint authentication function of the example to the smartphone.

### DESCRIPTION OF EMBODIMENTS

### Example

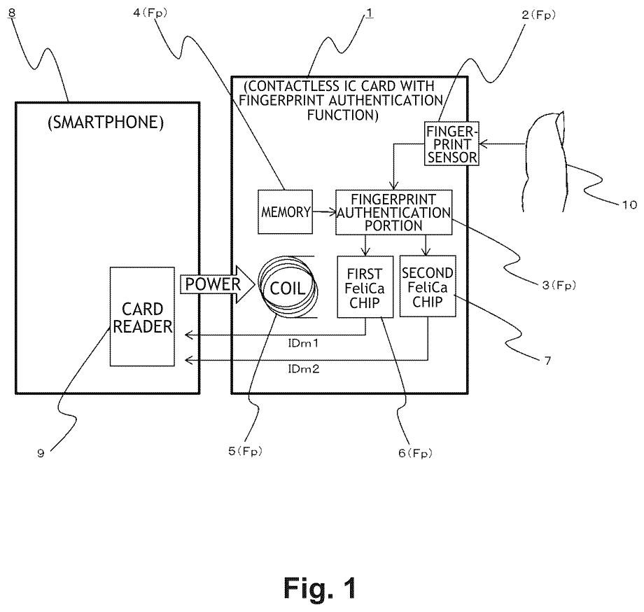

FIG. 1 is a block diagram of a fingerprint authentication system related to the present invention. In the drawing, reference numeral 1 denotes a contactless IC card with a smartphone-compatible fingerprint authentication function. Reference numeral 2 denotes a statistical-capacitance type thin-shaped fingerprint sensor. Reference numeral 3 denotes a fingerprint authentication portion. Reference numeral 4 denotes a memory for storing verification fingerprint data. Reference numeral 5 denotes a coil for receiving power from the contactless IC card reader. Reference numeral 6 denotes a first NFC chip having a function of performing NFC communication or typically is a FeliCa chip. Reference numeral 7 denotes a second NFC chip having a function of performing the NFC communication or typically is a FeliCa chip.

Reference numeral 8 denotes a smartphone cooperating with the contactless IC card 1 with a smartphone-compatible fingerprint authentication function. Reference numeral 9 denotes the contactless IC card reader incorporated in the smartphone 8, and 10 denotes a finger of a user who registered the fingerprint.

In an example of the present invention in FIG. 1, in the illustrated fingerprint authentication system, devices mounted on the contactless IC card 1 with a smartphone-compatible fingerprint authentication function, that is, the fingerprint sensor 2, the fingerprint authentication portion 3, the memory 4 storing the verification fingerprint data, the coil 5, and the first NFC chip (first FeliCa chip 6) constitute fingerprint authentication means Fp. In the fingerprint authentication means Fp, on condition that power is supplied from the contactless IC card reader 9 incorporated in the smartphone 8 to the coil 5, the coil 5 which received the power supplies the power to the fingerprint sensor 2, the fingerprint authentication portion 3, the memory 4 and the like, and the fingerprint authentication is started. At this time, the fingerprint authentication portion 3 controls the first FeliCa chip 6 by a method of stopping the power supply to the first FeliCa chip 6 or the like so that the first FeliCa chip 6 is not operated.

After the start of the fingerprint authentication, if the finger 10 whose fingerprint is registered in advance touches the fingerprint sensor 2, the fingerprint authentication portion 3 verifies the fingerprint data of the finger 10 read from the fingerprint sensor 2 against the verification fingerprint data stored in the memory 4.

When the fingerprints are authenticated to match each other in this verification, such control is executed that the first FeliCa chip 6 is operated. As a result, the contactless IC card reader 9 is brought into a state where the IDm1 data of the first FeliCa chip 6 can be read. This state is maintained until the power supply to the coil 5 is stopped.

On the other hand, before the fingerprint authentication or when the fingerprints are not authenticated to match each other, the fingerprint authentication portion 3 executes control so that the first FeliCa chip 6 is not operated, and such a state that the IDm1 data is not read is maintained. By means of the aforementioned control, the IDm1 data in the first FeliCa chip 6 can be read out by the contactless IC card reader 9 only when the fingerprints are authenticated to match each other. In other words, if the fingerprints are not authenticated to match each other, the IDm1 data of the first FeliCa chip 6 cannot be read out by the contactless IC card reader 9.

It is constituted such that, only when the two conditions, that is, first, the IDm1 data of the FeliCa chip 6 can be read by the contactless IC card reader 9 and secondly, the IDm1 data registered in advance in the smartphone 8 matches the IDm1 data of the FeliCa chip 6, are satisfied, the fact that “the fingerprint authentication by the contactless IC card 1 with a smartphone-compatible fingerprint authentication function was successful” can be recognized by the smartphone 8. In this case, in the smartphone 8, authentication is made by two factors, that is, the fingerprint and the IDm data of the FeliCa, which can provide security higher than simple fingerprint authentication.

In the fingerprint authentication system shown in FIG. 1, the first FeliCa chip 6 is used as the first NFC chip which performs the NFC communication with the contactless IC card reader 9. For example, since the contactless IC card reader 9 supports the NFC-standard wireless communication, other NFC-standard NFC chips such as Mifare (Registered Trademark) may be used as long as it is an NFC chip capable of the NFC communication.

In the fingerprint authentication system shown in FIG. 1, a notification method to the contactless IC card reader 9, when the fingerprint authentication portion 3 “authenticated that the fingerprints match each other”, is realized by bringing the IDm1 data into a readable state. As a variation, another data or combination of IDm and another data may be brought into a readable state.

A method for realizing the notification method can be realized also by the first FeliCa chip 6 transmitting determined data, and by the contactless IC card reader 9 receiving that, in a case where the fingerprint authentication portion 3 authenticates that the fingerprints match each other simply by a predetermined command from the contactless IC card reader 9. However, by transmitting the same data as the determined data to the card reader 9 by some different means, even if the fingerprint authentication portion 3 does not authenticate that the fingerprints match each other, it is considered to be “authenticated that the fingerprints match each other”, and there is a concern that it is exploited as a method of breaking security, where attention should be paid to such abuse.

Regarding this abuse, when another contactless IC card 1 with a smartphone-compatible fingerprint authentication function in which another fingerprint was registered is cooperated with the smartphone 8, for example, in order to prevent the smartphone 8 side from operating as being fingerprint-authenticated, it is preferable to adopt such a measure that providing specific data on the side of the contactless IC card 1 with a smartphone-compatible fingerprint authentication function so that the matching with the data registered on the side of the smartphone 8 is an indispensable condition of the successful fingerprint authentication.

In the fingerprint authentication system shown in FIG. 1, the notification method is realized by transmission of the IDm1 data of the first FeliCa chip 6, and there is no FeliCa chip with the same IDm data and thus, it is difficult to break the security without fingerprint authentication as above. That is, it is actually difficult to break the security by causing the smartphone 8 side to recognize that “the fingerprint authentication was successful” by using some unlawful means.

The IDm is used in the authentication of general-purpose security cards and there is no big problem at present. However, there is such an opinion that the communication method and the like of the IDm are disclosed, and forgery is possible. In the general-purpose FeliCa card, the IDm data can be easily read by skimming, which is another problem. In the fingerprint authentication system shown in FIG. 1, it is controlled such that the IDm1 data can be read, only when the fingerprint authentication portion 3 authenticates the matching of the fingerprints. As a result, since skimming is also impossible without authentication of matching of the fingerprints, a risk of the skimming can be drastically reduced.

As a measure against IDm forgery of the FeliCa card, a method of MAC authentication by a secret key for the FeliCa Lite-S chip, a method of using a secure region for the FeliCa Standard chip and the like are proposed, and such methods can be applied to the notification method of the fingerprint authentication system shown in FIG. 1 as appropriate.

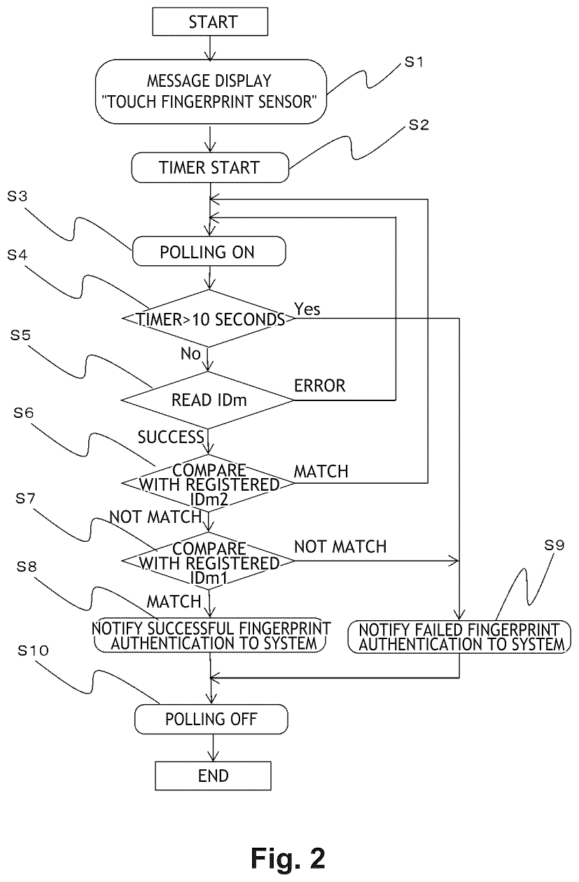

In the fingerprint authentication system shown in FIG. 1, an example of a control method of controlling an electronic circuit incorporated in the contactless IC card 1 with a smartphone-compatible fingerprint authentication function by the smartphone 8 will be explained on the basis of a flowchart shown in FIG. 2.

When the application software installed in the smartphone 8 is activated, a message “touch the fingerprint sensor” is displayed on a display of the smartphone 8 in FIG. 1 at the first Step S1, and an incorporated timer is started (S2). In this software, a command to turn on polling is transmitted to the contactless IC card reader 9 (S3), the contactless IC card reader 9 starts polling and supplies power to the coil 5.

The coil 5 which received supply of power supplies power to the fingerprint sensor 2, the fingerprint authentication portion 3, the memory 4 and the like. As a result, the fingerprint authentication is started. At the subsequent Step S4, until 10 seconds elapse on the timer, this software proceeds to Step S5, while if 10 seconds have elapsed, it proceeds to Step S9.

This software transmits a command for reading the IDm data to the contactless IC card reader 9 at Step S5. The contactless IC card reader 9 replies whether or not the reading of the IDm data was successful to this software. If the reading of IDm failed or if the IDm data read at the subsequent Step S6 matches IDm2 data of the second FeliCa chip 7, the processing returns to Step S3 and repeats the polling.

An important point in a state where the polling is repeatedly performed is that it takes arithmetic time of 1 to 2 seconds for the fingerprint authentication portion 3 to complete the finger print authentication. During a period of this loop, such a state is needed where the coil 5 can continuously receive power all the time. Therefore, by setting time for power supply to the contactless IC card reader 9 at one time of the polling command longer to some degree by a parameter of the command or the like, it is necessary to bring the coil 5 into a state where power supply can be continuously received all the time.

At Step S6, if the read IDm data does not match the IDm2 data of the second FeliCa chip 7, the processing proceeds to Step S7. Only when the matching is authenticated by the fingerprint authentication portion 3, the IDm1 data of the first FeliCa chip 6 can be read out by the contactless IC card reader 9. Therefore, if the IDm data read at Step S7 matches the IDm1 data registered in advance in the smartphone 8, it is notified that “the fingerprint authentication by the contactless IC card 1 with a smartphone-compatible fingerprint authentication function succeeded” to the system in the smartphone 8 (S8).

On the other hand, if the IDm data does not match at Step S7, it is considered that the contactless IC card reader 9 read the IDm data of another FeliCa card. As a result, it is notified that “the fingerprint authentication failed in the contactless IC card 1 with a smartphone-compatible finger authentication function” to the system in the smartphone 8 (S9). After the result of the fingerprint authentication is notified to the system, the polling is turned off (S10), and this application software is finished.

When the system in the smartphone 8 recognizes that “the fingerprint authentication succeeded in the contactless IC card 1 with a smartphone-compatible fingerprint authentication function”, it releases the lock or allows connection to a specific network. That is, according to the fingerprint authentication system shown in FIG. 1, the contactless IC card 1 with a smartphone-compatible fingerprint authentication function can be used as a fingerprint authentication device in the smartphone 8.

The inventor of the present application created the application software according to the flowchart shown in FIG. 2, which conforms to iPhone by Apple, Inc in the States and verified actual operations. Recent iPhones incorporate contactless IC card readers. In the iPhone, the application software was created by using CoreNFC, which is an NFC-standard communication framework conforming to the OS of iOS13 and after. And it was confirmed that reading/writing of the NFC-standard card such as general-purpose FeliCa cards and the like can be made by using the contactless IC card reader incorporated in the iPhone.

The application software for iPhone in compliance with the flowchart shown in FIG. 2 was created by using the CoreNFC, and the operation was verified and then, it was confirmed that IDm and UID of the NFC-standard cards such as the general-purpose FeliCa cards, the Mifare cards and the like can be read. However, for the fingerprint authentication system shown in FIG. 1, such problems were found that, in a state where the second NFC chip (second FeliCa chip 7) is held all the time so as not to be operated, continuous power-supply cannot be performed or the fingerprint authentication or the reading of the IDm1 cannot be executed.

Even if the second NFC chip (second FeliCa chip 7) is in a state held all the time so as not to be operated, the fingerprint authentication can be executed by performing the continuous power-supply from the contactless IC card reader. And if the fingerprint authentication succeeded, it is operated as the FeliCa card, and IDm1 can be read. This is the same operation as that of the contactless IC card with a fingerprint authentication function which has been already developed/sold.

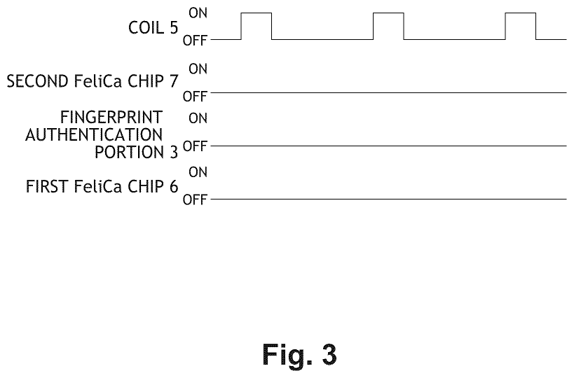

In the fingerprint authentication system shown in FIG. 1, in the state where the second NFC chip (second FeliCa chip 7) is held all the time so as not to be operated, the power-supply state to the coil 5 when the application software for iPhone based on the flowchart shown in FIG. 2 is activated is shown in FIG. 3. FIG. 3 is a timing chart of the first example. The aforementioned problem, that is, the problem that the continuous power supply cannot be made was examined and as a result, the inventor of the present application found out that the problem was caused by initial setting of a period during which the power is supplied at one time by the polling command being short. Against this problem, even if the period during which one-time polling is performed is to be prolonged by changing a timeSlot value of a parameter of Polling command and the like of the CoreNFC, actual power-supply period is not changed. Thus, as is known from FIG. 3, power-supply to the coil 5 only for a short time is repeated periodically. Therefore, in the iPhone, it was known that in the state where the fingerprint authentication system shown in FIG. 1 is held all the time so that the second NFC chip (second FeliCa chip 7) is not operated, the continuous power-supply state cannot be realized only by the application software.

In a state where the NFC-standard cards such as the genera-purpose FeliCa card, Mifare card and the like are brought close to the contactless IC card reader 9 incorporated in the iPhone, that is, in a state capable of the NFC communication, a change of the timeSlot value is made effective, and the power-supply period can be also prolonged. However, the second NFC chip (in a state where the second FeliCa chip 7 is held all the time so as not to be operated, the first NFC chip (first FeliCa chip 6) is brought into the state where the fingerprint authentication system shown in FIG. 1 becomes capable of the NFC communication is only after the successful fingerprint authentication. And if the power-supply period cannot be prolonged, the fingerprint authentication is not completed. Thus, the change of the timeSlot value is not made effective, and the power-supply period cannot be prolonged.

With this application software, when the NFC-standard card such as the general-purpose FeliCa card, the Mifare card and the like is brought close to the incorporated contactless IC card reader 9 in a state where the software is operated, the NFC communication is performed, and the change of the timeSlot value is made effective. And the actual polling period was prolonged, and such a state is brought about that the power supply is continuously performed. By realizing the continuous power-supply state, the fingerprint authentication system shown in FIG. 1 can perform the fingerprint authentication, and it was confirmed that, after the fingerprint authentication succeeded, such a state was brought about that the first FeliCa chip 6 is operated.

However, when the card to be brought close to the contactless IC card reader 9 in order to change the timeSlot value is the Mifare card, in the fingerprint authentication system shown in FIG. 1, even after the successful fingerprint authentication, the incorporated contactless IC card reader 9 read UID, which is the specific data of the Mifare card, but could not read the IDm1 data of the first FeliCa chip 6. The inventor of the present application thought that it was because the incorporated contactless IC card reader 9 first performed the NFC communication with the Mifare card and tried to maintain the communication with the Mifare card as it is ant thus, the communication with the first FeliCa chip 6 was not performed.

In order to solve this problem, it is necessary to perform the NFC communication after the start of the power supply to the coil 5 so that the incorporated contactless IC card reader 9 can be brought into the continuous power-supply state, and the change of the timeSlot value can be made effective and the card reader can actually read the IDm of the first FeliCa chip 6 in the continuous power-supply state.

In the NFC communication standard, a communication sequence between the contactless IC card reader and the NFC card is constituted, at first, by an “initial response” which sets a communication path between the contactless IC card reader and the target NFC card and secondly, an “active state” in which information is sent/received in accordance with the application.

First, when the power supply from the contactless IC card reader is started in the initial response, the NFC card is brought into a standby state of waiting for a setting request (request command) of the communication path from the contactless IC card reader. Then, the request command is transmitted from the contactless IC card reader, and the NFC card returns a response. As a result, the NFC card which is present in a communication area of the contactless IC card reader is recognized. After that, the contactless IC card reader exchanges parameters with the recognized NFC card and mutually confirms conditions such as a communication speed. After this, the initial response transfers to an active state. In the active state, the NFC card recognized in the initial response is selected, and the NFC communication is performed by repeating a response from the NFC card to the command from the contactless IC card reader.

The NFC cards include a type A such as the Mifare card and the like, a type B such as a driver's license in Japan and the like, and a type F such as the FeliCa card, and a processing method when a plurality of the same types of the NFC cards are present at the same time in the initial response is specified for each type. When the plurality of NFC types of cards are present, by specifying the type of a card to be read, only the specified type of card can be recognized. When a plurality of types are specified, the specified plurality of types of cards can be recognized. However, if the Mifare card and the FeliCa card are recognized at the same time, for example, there is such a restriction not clearly specified in the NFC communication standard that the UID of the Mifare card is read with priority over the IDm of the FeliCa card or the like.

The type A card such as the Mifare card adopts such a method that, (i) when a plurality of Mifare cards are recognized at the initial response, the UIDs of all the recognized Mifare cards are read by a method called a bit-collision method and then, (ii) one of the read UIDs is specified by the contactless IC card reader; and (iii) by means of the response by the Mifare card whose UID matches, one of the plurality of Mifare cards is selected. Therefore, the Mifare card which did not respond in the initial response cannot be selected.

There can be such methods that: (i) with the FeliCa card, if the IDm is known, the IDm is specified and the FeliCa card matching it responds; and (ii) if system codes of the plurality of FeliCa cards are different, the IDm data of the corresponding FeliCa card can be read by specifying the system code even when the cards are stacked. In order to change the timeSlot value at the initial response, when the FeliCa card to be brought close to the contactless IC card reader 9 is a FeliCa card with a system code different from that of the first FeliCa chip 6 included in the fingerprint authentication system shown in FIG. 1, even if the FeliCa card is as it is after the successful fingerprint authentication, it was confirmed that the IDm1 data of the first FeliCa chip 6 could be read by the incorporated contactless IC card reader 9 specifying the system code of the first FeliCa chip 6 on the side of the contactless IC card 1 with a smartphone-compatible fingerprint authentication function. Since the FeliCa card which responded initially has the system code different from that of the first FeliCa chip 6, the IDm is in the non-readable state, but it was confirmed to be in the continuous power-supply state.

With the contactless IC card reader 9 incorporated in the iPhone, when some NFC card is recognized in the initial response, the change of the timeSlot value is made effective. However, in order for the first NFC chip (first FeliCa chip 6) having the function of the NFC communication on the side of the contactless IC card 1 with a smartphone-compatible fingerprint authentication function to be able to notify the contactless IC card reader 9 that the fingerprint authentication succeeded after the successful fingerprint authentication by maintaining the continuous power-supply state, control timing of the NFC card function recognized in the initial response and the type of the NFC chip and the type of the first NFC chip having the function of the NFC communication on the side of the contactless IC card 1 with a smartphone-compatible fingerprint authentication function need to be combined favorably.

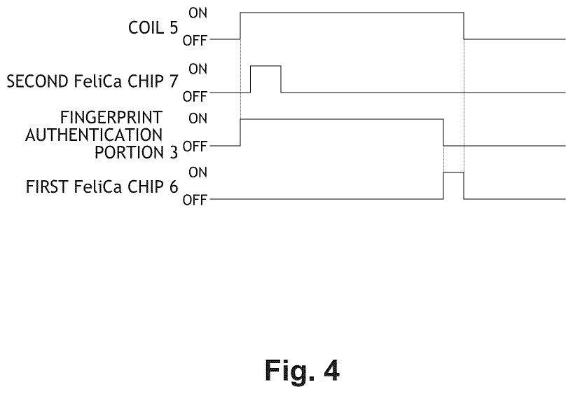

In the fingerprint authentication system shown in FIG. 1, the power-supply state to the coil 5 when the application software for iPhone is started on the basis of the flowchart shown in FIG. 2 is illustrated in FIG. 4. FIG. 4 is a timing chart of a second example. With reference to FIG. 4, apart from the first Felica Chip 6 operated when the fingerprint authentication is successful, a second FeliCa chip 7 recognized in the initial response in order to make the change of the timeSlot value effective is added into the contactless IC card 1 with a smartphone-compatible fingerprint authentication function so that, when power is supplied to the coil 5, the second FeliCa chip 7 is brought into an operable state only for a short time with a delay. In this short time, the initial response of the NFC communication is performed between the incorporated contactless IC card reader 9 and the second FeliCa chip 7, the change of the timeSlot value is made effective, the period of the actual polling is prolonged, and such a state in which the continuous power-supply is performed is realized.

In the timing chart of the second example in FIG. 4, the second FeliCa chip 7 is brought into the operating state with a slight delay from the power supply to the coil 5, but the operating state may be realized at the same time. The delay time is provided so as to delay a recognized order so that the second FeliCa chip 7 does not interfere with the communication of another NFC card when the contactless IC card 1 with a smartphone-compatible fingerprint authentication function is used by being overlapped with another NFC card and the like.

If the second NFC chip is a FeliCa chip, since the same IDm chips do not exist, when the fingerprint authentication does not succeed, the IDm that can be read by the external contactless IC card reader is an IDm2 of the second FeliCa chip 7. In addition, if only the FeliCa chip is recognized in the initial response, then, not only when the system codes of the two FeliCa chips are different but also even when the system code of the second FeliCa chip 7 is the same as the system code of the first FeliCa chip 6, the NFC communication can be performed after the transfer to the active state in a case where the number of FeliCa chips operating at the same time is one, and the IDm of the FeliCa chip operating at that time can be read.

Thus, by controlling two pieces of the FeliCa Lite-S chips at a lower price so as not to operate at the same time, even if they are mounted in the contactless IC card 1 with a smartphone-compatible fingerprint authentication function, the IDm2 of the second FeliCa chip 7 can be read after the power supply to the coil 5, and after the successful fingerprint authentication, the IDm1 of the first FeliCa chip 6 can be read. By actively using that, for an application with strict security, the fingerprint authentication is performed, and the IDm1 is used (first mode), while for an application with less strict security, the fingerprint authentication is not performed but the IDm2 can be casually used (second mode), whereby convenience is improved. The second mode can be used in a state where the fingerprint authentication is not successful. For example, the second mode can be reliably used by preventing the finger from touching the fingerprint sensor.

In addition, in the timing chart in FIG. 4, there is a period when all the NFC chips are stopped after the second NFC chip was brought into an operable state only for a short period of time. By means of this period, the card information recognized in the initial response is initialized. Even if all the NFC chips are stopped, the continuous power-supply state is maintained for a certain period of time, the fingerprint authentication is performed, and after the successful fingerprint authentication, the first NFC chip is brought into the operating state. Then, since the recognition of the first NFC chip is performed in the subsequent initial response, the first NFC chip can notify the contactless IC card reader 9 of the successful fingerprint authentication without a problem.

As a result, with the timing chart in FIG. 4, even if the second NFC chip is a MiFare chip, the MiFare chip is brought into the operable state only for a short period of time, and after the continuous power-supply state is brought about in the initial response, all the NFC chips including the MiFare chip are stopped, and only the first FeliCa chip 6 is brought into the operable state after the successful fingerprint authentication and thus, the first FeliCa chip makes an initial response, and the IDm1 can be read.

That is, in the timing chart in FIG. 4, selection can be expanded to the first NFC chip and the second NFC chip. In principle, there is no limitation to the combinations of the two NFC chips, but with which selection the operation actually has no problem needs to be verified for each model of the smartphone. In addition, since the MiFare chip is brought into the operable state in a short period of time, attention should be paid to whether any problem occurs in the NFC communication at payment of electronic money using the incorporated contactless IC card reader with another application software or the like.

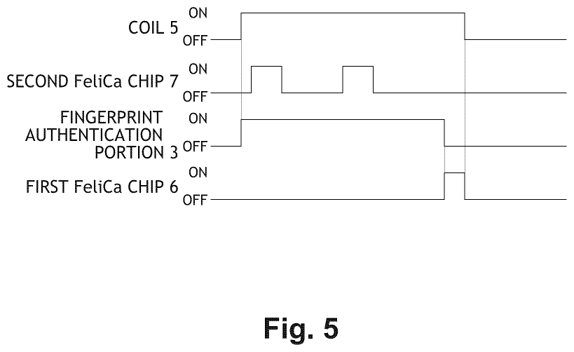

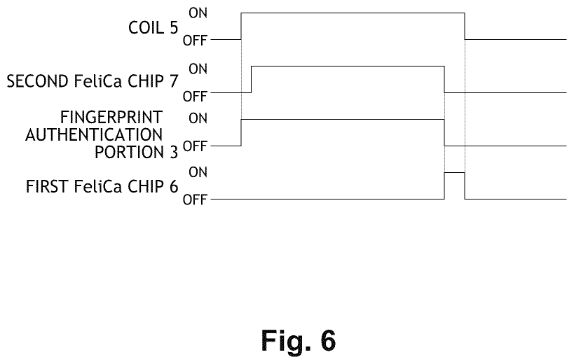

In the fingerprint authentication system shown in FIG. 1, the power-supply state to the coil 5 when the application software for iPhone based on the flowchart shown in FIG. 2 is started is illustrated in FIG. 5, FIG. 6. FIG. 5, FIG. 6 are timing charts of a third example, a fourth example, and in these timing charts, similarly to the explanation with reference to the timing chart of the second example in FIG. 4, the second NFC chip (second FeliCa chip 7) recognized in the initial response is added into the contactless IC card 1 with a smartphone-compatible fingerprint authentication function, and when power is supplied to the coil 5, the second NFC chip (second FeliCa chip 7) is brought into the operating state with a slight delay. In the timing chart of the third example in FIG. 5, the second NFC chip (second FeliCa chip 7) is brought into the operating state twice, and in the timing chart of the fourth example in FIG. 6, the second NFC chip (second FeliCa chip 7) is held in the operating state until the fingerprint authentication succeeded. They are performed in order to delay the timing to stop the second NFC chip (second FeliCa chip 7) with respect to the aforementioned timing in the second example in FIG. 4.

With the iPhone, the continuous power-supply is enabled by making the change of the timeSlot value effective in the initial response, but if the communication with the NFC chip is stopped after the transfer from the initial response to the active state, the continuous power-supply is released after a certain period of time. The longest time of the continuous power-supply is prolonged by (i) bringing into the operating time for a short period of time again after the communication with the second NFC chip (second FeliCa chip 7) is stopped as in the timing chart of the third example in FIG. 5; and (ii) by maintaining the communication of the second NFC chip (second FeliCa chip 7) until the fingerprint authentication succeeds as in the timing chart of the fourth example in FIG. 6. Therefore, it is preferable to configure such that, in accordance with the smartphone to be used, settings of parameters such as settings of the delay time, the operation time, the repetition period of time, the number of repetition times and the like can be changed until the second NFC chip (second FeliCa chip 7) is brought into the operating state from the start of the power-supply. In addition, since the second NFC chip (second FeliCa chip 7) is capable of the NFC communication even for a short period of time, there is a risk that the IDm2 is read by skimming. In order to avoid this, it is preferable to configure that settings of the control method of the second FeliCa chip 7 can be changed with a touch of the finger on the fingerprint sensor as an additional parameter such that, whether the finger touches the fingerprint sensor is detected, and if the finger is not touching, the second FeliCa chip 7 is not operated, and the operation is controlled so that the IDm2 cannot be read or the like, for example.

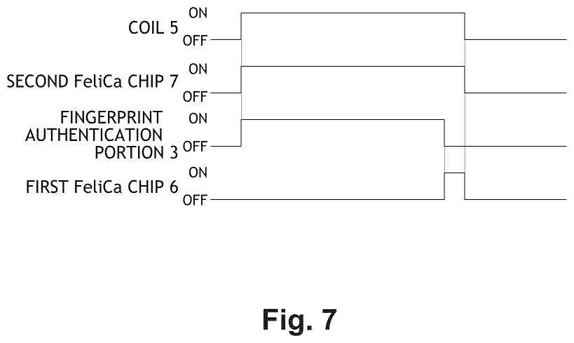

In the fingerprint authentication system shown in FIG. 1, the power-supply state when the application software for iPhone based on the flowchart shown in FIG. 2 is activated is illustrated in FIG. 7. FIG. 7 is a timing chart of a fifth example.

Similarly to the timing chart of the second example in FIG. 4, the second NFC chip (second FeliCa chip 7) recognized in the initial response is added to the contactless IC card 1 with a smartphone-compatible fingerprint authentication function, and when power is supplied to the coil 5, the second NFC chip (second FeliCa chip 7) is brought into the operating state, and the operating state is maintained until the power supply to the coil 5 is stopped.

With reference to FIG. 7, after the successful fingerprint authentication, not only the first FeliCa chip 6 but also the second FeliCa chip 7 is brought into the operating state at the same time. Therefore, it is necessary to select a type of such a FeliCa chip that, even in the state where the second FeliCa chip 7 which initially responded is operating, the IDm1 of the first FeliCa chip 6 which did not respond initially can be read.

As described above, regarding the FeliCa, if only the FeliCa chip responds in the initial response, a plurality of the FeliCa chips can be also read after that. In order to read the plurality of FeliCa chips, the IDm should be specified, or the system code should be specified so that the applicable FeliCa chip responds. However, there is no method of specifying the IDm in the CoreNFC. Thus, the corresponding FeliCa chip should be read by specifying the system code. In this case, if the plurality of system codes are specified, the FeliCa chips corresponding to them can be also read at the same time.

Since when there are a plurality of FeliCa chips with the same system code, they cannot be read at the same time and thus, it is only necessary that the second FeliCa chip 7 is a FeliCa chip with a system code different from that of the first FeliCa chip 6.

As in the timing chart of the fifth example in FIG. 7, when the second FeliCa chip 7 and the first FeliCa chip 6 are set as two pieces of the FeliCa chips with different system codes, and when the second FeliCa chip 7 is brought into the continuously operating state during the power-supply period to the coil 5 regardless of the fingerprint authentication, there is no need for the second FeliCa chip 7 to match the timing with the fingerprint authentication portion 3. Thus, in the fingerprint authentication system shown in FIG. 1, it becomes possible to add a second coil which is different from the coil 5 dedicated for the second FeliCa chip 7. The same function as the general-purpose FeliCa card function is constituted, and an independent circuit board which is not connected by wire with another circuit in the contactless IC card 1 with a smartphone-compatible fingerprint authentication function can be realized.

The second FeliCa chip 7 and a FeliCa card corresponding to the second coil or an equal function can be independently constituted in a seal or a flexible board module shape and can be also constituted by a method of bonding on a card surface of the contactless IC card 1 with a smartphone-compatible fingerprint authentication function or the like. It was confirmed that the constitution as above operated without a problem.

As described above, according to the examples explained on the basis of the timing charts shown in FIG. 4, FIG. 5, FIG. 6, and FIG. 7, even the smartphone such as iPhone or the like, for which the power supply from the contactless IC card reader 9 incorporated in the smartphone 8 cannot be originally made continuous only with the application software, (i) by mounting the fingerprint authentication function on the contactless IC card 1 with a smartphone-compatible fingerprint authentication function; (ii) by starting the fingerprint authentication upon receipt of power supply from the contactless IC card reader 9 incorporated in the smartphone 8; (iii) by recognizing the second NFC chip in the initial response, to bring the power supply into the continuous state; (iv) when the fingerprint authentication succeeds, the contactless IC card reader 9 receives the fingerprint authentication notification from the first NFC chip, whereby the fact that “matching of the fingerprints was authenticated” can be notified to the smartphone 8. Thus, the fingerprint authentication function can be substantially added to the smartphone 8.

The inventor of the present application tested the contactless IC card 1 with a smartphone-compatible fingerprint authentication function operated on the iPhone on the basis of the present invention with a system in which the contactless IC card reader is connected to a personal computer. Then, it was confirmed that the continuous power-supply state is not brought about without changing the software for controlling the contactless IC card reader installed in the personal computer, and even in a system in which the existing fingerprint authentication card is not operated, the continuous power-supply state is obtained by holding the contactless IC card 1 with a smartphone-compatible fingerprint authentication function without changing the software for some of the systems, and the function of the fingerprint authentication can be used.

When a contactless IC card 1 with a smartphone-compatible fingerprint authentication function is to be used in a system in which the contactless IC card reader is connected to a personal computer, specific data such as IDm1 and the like read by the contactless IC card reader needs to be registered in the system before the use. For that purpose, in a state where the fingerprint information is not registered in the contactless IC card with a smartphone-compatible fingerprint authentication function, for example, by controlling such that, if power is supplied in a wireless manner, the first NFC chip (first FeliCa chip 6) is operated, and the second NFC chip (second FeliCa chip 7) is not operated, it becomes easier to register the specific data such as the aforementioned IDm1 and the like in the system. At that time, even if the software of the system cannot control the contactless IC card reader connected to the personal computer in the continuous power-supply state, the specific data such as the IDm1 and the like can be read in a short period of time and thus, it becomes possible to register the specific data such as IDm1 and the like in the system without changing the software.

In addition, in a system in which the contactless IC card reader is connected to some of personal computers, if a FeliCa card is removed from the contactless IC card reader, it is determined that the card holder left the seat and the personal computer is locked. For such a system, in the contactless IC card 1 with a smartphone-compatible fingerprint authentication function of the present invention, such a state that the first NFC chip (first FeliCa chip 6) is continuously operated after the fingerprint authentication is not desirable in security. Therefore, it is preferable that the first NFC chip (first FeliCa chip 6) is operated for a certain period of time and then, stops the operation after the fingerprint authentication and instead, the second NFC chip (second FeliCa chip 7) is continuously operated, and the IDm2 is used for determination of leaving the seat. Regarding the operation of the two NFC chips after a certain period of time has elapsed after the successful fingerprint authentication, it is preferable to constitute such that the setting can be changed for each card in accordance with the system to be used.

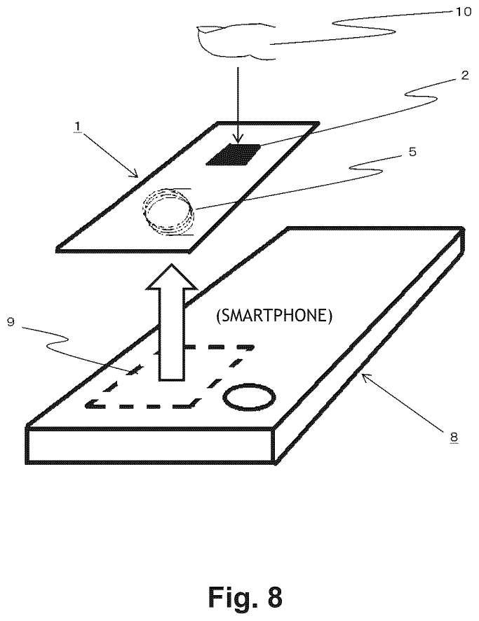

FIG. 8 is an explanatory diagram of a case in which the contactless IC card 1 with a smartphone-compatible fingerprint authentication function of an example of the present invention is bonded to the smartphone 8 by using a double-sided tape, for example. In FIG. 8, the same elements as those shown in FIG. 1 are given the same reference numerals. With reference to FIG. 8, inside the contactless IC card 1 with a fingerprint authentication function, the coil 5 is formed by a copper-foil print pattern, and electronic-circuit components such as the fingerprint authentication portion 3, the memory 4, the first FeliCa chip 6, the second FeliCa chip 7 and the like shown in FIG. 1 are mounted other than the fingerprint sensor 2.

The size of the contactless IC card 1 with a smartphone-compatible fingerprint authentication function usually aligns with a standardized credit card dimension, but in FIG. 8, the size is reduced to an elongated shape so that a camera on a rear surface can be used in a state bonded to the smartphone 8. The contactless IC card 1 with a smartphone-compatible fingerprint authentication function can be manufactured with a thickness of 0.76 mm, which is the same as that of a credit card, and by bonding it to the smartphone as in FIG. 8, it can be used in an integrated state almost without increasing the thickness of the smartphone, and the functions / convenience equal to those of a fingerprint authentication device incorporated in the smartphone can be provided.

In the fingerprint authentication system shown in FIG. 1, as in the timing chart of the second example in FIG. 4, for example, when the power supply from the contactless IC card reader 9 is started, such control is executed that the first NFC chip (first FeliCa chip 6) performing the NFC communication is not operated until the fingerprint authentication portion 3 authenticates that the fingerprints match each other. Even when the finger does not touch the fingerprint sensor 2, the first NFC chip (first FeliCa chip 6) performing the NFC communication is controlled so as not to be operated. The second NFC chip (second FeliCa chip 7) is controlled so as to be operated only for a short period of time, when the power supply from the contactless IC card reader 9 is started.

As a result, in a state where the contactless IC card 1 with a smartphone-compatible fingerprint authentication function is bonded to the smartphone 8 as in FIG. 8, not only that the fingerprint authentication function can be used in the smartphone but also (i) when another contactless IC card is to be read by the contactless IC card reader 9 incorporated in the smartphone 8; and (ii) when the NFC communication is to be performed between the contactless IC card reader 9 incorporated in the smartphone 8 and various external devices for payment of electronic money or the like, even in a state where power is supplied also to the coil 5 in the contactless IC card 1 with a smartphone-compatible fingerprint authentication function, interference with the NFC communication of the contactless IC card reader 9 is prevented.

Particularly by using the second NFC chip as the FeliCa chip, it does not interfere with reading of the Mifare card. It is preferable to adopt the FeliCa chip with a different system code or specifically a FeliCa Lite-S chip as the second NFC chip (second FeliCa chip 7) so that the contactless IC card reader 9 incorporated in the smartphone 8 does not cause a problem, when a FeliCa Standard system code is used in payment of electronic money or the like. In this case, if the second NFC chip and another FeliCa Lite-S card are in the operating state at the same time, there is a trouble in reading, but since the second NFC chip (second FeliCa chip 7) operates only for a short period of time when the power supply from the contactless IC card reader 9 is started, there is substantially no problem.

When the contactless IC card reader 9 incorporated in the smartphone 8 is to perform the NFC communication with various external devices for payment of electronic money or the like immediately after the successful fingerprint authentication, after the smartphone 8 recognizes that the fingerprint authentication succeeded, the first NFC chip (first FeliCa chip 6) can be controlled not to be operated by stopping power supply from the contactless IC card reader 9 once.

A rear surface of the current smartphone is occupied by an incorporated battery and an incorporated camera, and the incorporated contactless card reader 9 is stored in a narrow width on the side of the camera. This positional relation is substantially the same in currently sold smartphones, and the card shape in FIG. 8 can be designed to be such a shape that can be applied to smartphone models with a plurality of different sizes.

Regarding an operation of the fingerprint authentication system shown in FIG. 1, though source codes of the application software are different in accordance with the OS of the smartphone, the fingerprint authentication system does not depend on the OS, but the same contactless IC card 1 with a smartphone-compatible fingerprint authentication function can be used for the smartphone with a different OS. Therefore, by designing a card shape that can be bonded to various smartphones, the contactless IC card 1 with a smartphone-compatible fingerprint authentication function in the same shape can be mass-produced, and costs can be reduced. In addition, since a line for producing credit-card sized contactless IC cards is used for manufacture of the cards, to have such a shape that two or more pieces of cards within the credit-card size, the card manufacturing costs can be lowered.

In the example of the present invention, a case in which a FeliCa chip mounted on a FeliCa card sold in the market is used as the first FeliCa chip 6 and the second FeliCa chip 7 is explained, but by adding such a mode that IDm cannot be read in the initial response by customizing the FeliCa chip so that reading of IDm2 of the second FeliCa chip 7 is allowed by detecting a touch of a finger with the fingerprint sensor, it is easy for those skilled in the art to make it difficult to skim the IDm2 on the second FeliCa chip 7 or to reduce the cost by integrating the first FeliCa chip 6 and the second FeliCa chip 7 on one silicon chip and by reducing the size of a chip through sharing of a wireless communication part and the like.

### REFERENCE SIGNS LIST

1 Contactless IC card with a smartphone-compatible fingerprint authentication function
Fp Fingerprint authentication means
2 Fingerprint sensor
3 Fingerprint authentication portion
4 Memory
5 Coil
6 First NFC chip (first FeliCa chip)
7 Second NFC chip (second FeliCa chip)
8 Smartphone
9 Contactless IC card reader
10 Finger of user whose fingerprint was registered

1. A contactless IC card with a smartphone-compatible fingerprint authentication function, which can recognize successful fingerprint authentication by a smartphone incorporating a contactless IC card reader, comprising:
a fingerprint sensor;
a fingerprint authentication portion;
a memory for storing verification fingerprint data;
a first coil for receiving power from the contactless IC card reader; and
fingerprint authentication means including a first NFC chip having a function of performing NFC communication with the contactless IC card reader, wherein
the fingerprint authentication means has:
a fingerprint-data reading function which starts reading of fingerprint data by using the fingerprint sensor, when the first coil receives power from the contactless IC card reader;
a fingerprint-data verification function which matches the read fingerprint data against the verification fingerprint data stored in the memory by the fingerprint authentication portion; and
a fingerprint-authentication notification function of notifying to the contactless IC card reader that the fingerprints are authenticated to match each other since the first NFC chip can perform the NFC communication only when the fingerprints are authenticated to match by the fingerprint authentication portion;
the fingerprint sensor, the fingerprint authentication portion, the memory, the first NFC chip operate only by the power received by the first coil;
the smartphone is a model in which continuous power-supply cannot be performed from the contactless IC card reader to the first coil only by the application software installed therein, including:
a second NFC chip, which is different from the first NFC chip; and
when the power is received by the first coil from the contactless IC card reader, in an initial response of the NFC communication, by causing the second NFC chip to be recognized, the continuous power-supply is performed from the contactless IC card reader to the first coil.

2. A contactless IC card with a smartphone-compatible fingerprint authentication function, which can recognize successful fingerprint authentication by a smartphone incorporating a contactless IC card reader, comprising:
a fingerprint sensor;
a fingerprint authentication portion;
a memory for storing verification fingerprint data;
a first coil for receiving power from the contactless IC card reader; and
fingerprint authentication means including a first NFC chip having a function of performing NFC communication with the contactless IC card reader, wherein
the fingerprint authentication means has:
a fingerprint-data reading function which starts reading of fingerprint data by using the fingerprint sensor, when the first coil receives power from the contactless IC card reader;
a fingerprint-data verification function which matches the read fingerprint data against the verification fingerprint data stored in the memory by the fingerprint authentication portion; and
a fingerprint-authentication notification function of notifying to the contactless IC card reader that the fingerprints match each other since the first NFC chip can perform the NFC communication only when the fingerprints are authenticated to match by the fingerprint authentication portion;
the fingerprint sensor, the fingerprint authentication portion, the memory, the first NFC chip operate only by the power received by the first coil;
the smartphone is a model in which continuous power-supply cannot be performed from the contactless IC card reader to the first coil only by the application software installed therein, including:
a second NFC chip, which is different from the first NFC chip, and
a second coil, which is different from the first coil; and
when the power is received by the second coil from the contactless IC card reader, in an initial response of the NFC communication, by causing the second NFC chip to be recognized, the continuous power-supply is performed from the contactless IC card reader to the first coil.

3. The contactless IC card with a smartphone-compatible fingerprint authentication function according to claim wherein
a fingerprint authentication notification which notifies that the fingerprint authentication succeeded, when the fingerprints are authenticated to match each other by the fingerprint authentication portion, transmits data using specific data stored in the first NFC chip to the contactless IC card reader by NFC communication.

4. The contactless IC card with a smartphone-compatible fingerprint authentication function according to claim 3, wherein
when the data using the specific data sent by the NFC communication from the first NFC chip to the contactless IC card reader and the data registered in advance in the smartphone are compared by the smartphone and matched, the smartphone recognizes that the fingerprints are authenticated to match each other by the fingerprint authentication portion.

5. The contactless IC card with a smartphone-compatible fingerprint authentication function according to claim 1, wherein
the first NFC chip and the second NFC chip are FeliCa chips with different system codes.

6. The contactless IC card with a smartphone-compatible fingerprint authentication function according to claim 1, wherein
the first NFC chip and the second NFC chip are FeliCa chips with the same system codes, and the first NFC chip and the second NFC chip do not perform the NFC communication at the same time.

7. The contactless IC card with a smartphone-compatible fingerprint authentication function according to claim 6, wherein
the first NFC chip and the second NFC chip are FeliCa Lite-S chips.

8. The contactless IC card with a smartphone-compatible fingerprint authentication function according to claim 1, wherein
in a state where the verification fingerprint data is not stored in the memory, the first NFC chip can perform the NFC communication, when power is received from the contactless IC card reader by the first coil.

9. The contactless IC card with a smartphone-compatible fingerprint authentication function according to claim 1, wherein
the first NFC chip and the second NFC chip are formed on the same silicon wafer.

10. The contactless IC card with a smartphone-compatible fingerprint authentication function according to claim 1, wherein
after the second NFC chip is recognized in an initial response, a period in which the first NFC chip and the second NFC chip are both stopped is provided, and the NFC communication is performed after the first NFC chip is recognized in the initial response after the successful fingerprint authentication.

11. The contactless IC card with a smartphone-compatible fingerprint authentication function according to claim 2, wherein
a fingerprint authentication notification which notifies that the fingerprint authentication succeeded, when the fingerprints are authenticated to match each other by the fingerprint authentication portion, transmits data using specific data stored in the first NFC chip to the contactless IC card reader by NFC communication.

12. The contactless IC card with a smartphone-compatible fingerprint authentication function according to claim 11, wherein
when the data using the specific data sent by the NFC communication from the first NFC chip to the contactless IC card reader and the data registered in advance in the smartphone are compared by the smartphone and matched, the smartphone recognizes that the fingerprints are authenticated to match each other by the fingerprint authentication portion.

13. The contactless IC card with a smartphone-compatible fingerprint authentication function according to claim 2, wherein
the first NFC chip and the second NFC chip are FeliCa chips with different system codes.

14. The contactless IC card with a smartphone-compatible fingerprint authentication function according to claim 2, wherein
the first NFC chip and the second NFC chip are FeliCa chips with the same system codes, and the first NFC chip and the second NFC chip do not perform the NFC communication at the same time.

15. The contactless IC card with a smartphone-compatible fingerprint authentication function according to claim 14, wherein
the first NFC chip and the second NFC chip are FeliCa Lite-S chips.

16. The contactless IC card with a smartphone-compatible fingerprint authentication function according to claim 2, wherein
in a state where the verification fingerprint data is not stored in the memory, the first NFC chip can perform the NFC communication, when power is received from the contactless IC card reader by the first coil.

17. The contactless IC card with a smartphone-compatible fingerprint authentication function according to claim 2, wherein
the first NFC chip and the second NFC chip are formed on the same silicon wafer.

18. The contactless IC card with a smartphone-compatible fingerprint authentication function according to claim 2, wherein
after the second NFC chip is recognized in an initial response, a period in which the first NFC chip and the second NFC chip are both stopped is provided, and the NFC communication is performed after the first NFC chip is recognized in the initial response after the successful fingerprint authentication.
